(19) United States
(12) Patent Application Publication
(10) Pub. No.: US 2018/0195234 A1
(43) Pub. Date: Jul. 12, 2018

(54) ENVIRONMENTALLY FRIENDLY WALLPAPER WITH WEATHERING RESISTANCE AND CONTAMINATING RESISTANCE AND PREPARING METHOD

(71) Applicant: SALIRONE INC., Huizhou (CN)

(72) Inventors: ZHAOHUI XIE, HUIZHOU (CN); SHENG HUANG, HUIZHOU (CN); CHIA-CHANG YANG, HUIZHOU (CN); CHANGLIN WU, HUIZHOU (CN); DONGSHENG JIAO, HUIZHOU (CN)

(21) Appl. No.: 15/917,468

(22) Filed: Mar. 9, 2018

Related U.S. Application Data
(63) Continuation of application No. PCT/CN2016/105893, filed on Nov. 15, 2016.

(30) Foreign Application Priority Data
Mar. 15, 2016 (CN) 201610122444.1

(51) Int. Cl. D06N 7/00; B32B 25/20

(52) U.S. Cl. CPC D06N 7/0002; B32B 25/20; D06N 2209/067; D06N 2211/063; D06N 2209/142; D06N 2209/1692; D06N 2209/043

(57) ABSTRACT

An environmentally friendly wallpaper with weathering resistance and contaminating resistance includes a substrate layer and a silicone rubber layer composite and connected together. The wallpaper is prepared by a process of calendering and attaching-pressing for patterning-vulcanizating. The process is simple and the production can be constant, resulting in high efficiencies; the entire process is free of harmful substances and polluters. The prepared wallpaper is environmentally friendly and wholesome, and the wallpaper has superior properties such as weathering resistance, contaminating resistance, flame resistance, moisture resistance and mould resistance.

### FIELD OF THE DISCLOSURE

The disclosure relates to a wallpaper technical field, and more particularly to an environmentally friendly wallpaper with weathering resistance and contaminating resistance, and a preparing method.

### BACKGROUND

Wallpapers are a kind of widely applied indoor decorative materials. The majority of domestic wallpapers in production and usage at present are added with various chemical additives, such as methylbenzene, cyclohexanone, acetone, gasoline and n-butyl acetate as solvents with additives like heavy metallic salts. The chemical additives are considerably remained in the wallpapers for sale, which can constantly release irritant gases and carcinogenic matters to the ambience to harm human health and the environment.

Silicone materials have excellent temperature resistance, weathering resistance, contaminating resistance, water resistance, flame resistance, electrical insulation and inherent inertness, as well as friendly to human bodies and the environment, which have been widely applied in each field of industries, health care and daily life such as aeronautics and astronautics, electrical and electronic engineering, architecture, automobile mechanics and the like. But the silicone has never been reported to be applied in producing wallpapers.

### SUMMARY

Aiming at the problem above, an environmentally friendly wallpaper with weathering resistance and contaminating resistance, harmlessness to health, waterproof and flameproof, and a preparing method are provided.

A technical solution provided by the disclosure to solve the technical problem above is as follows.

An environmentally friendly wallpaper with weathering resistance and contaminating resistance includes a substrate layer and a silicone rubber layer composite and connected together.

Preferably, a thickness of the silicone rubber layer is 0.1-1 mm.

Preferably, the substrate layer is paper, textile cloth or other coiled materials.

Preferably, the silicone rubber layer is formed by disposing silicone rubber on the substrate layer. The silicone rubber includes vinyl polysiloxane raw rubber, a filler, a constitution controller, a plasticizing agent, hydrogen-containing silicone oil, a platinum catalyst and a retarding agent.

Preferably, ingredients and mass ratios of the silicone rubber are as follows: 90-110 vinyl polysiloxane raw rubber, 40-100 filler, 1-15 constitution controller, 0.0001-2 plasticizing agent, 0.001-10 hydrogen-containing silicone oil, 0.0005-5 platinum catalyst, 0.001-5 retarding agent, 0-20 dyeing slurry, and 0-30 functional additive.

Preferably, the vinyl polysiloxane raw rubber is polysiloxane with at least two vinyl groups directly connected to Si, and an end of a main chain or a branched chain of the polysiloxane contains the at least two vinyl groups, or the end of the main chain and the branched chain both contain the at least two vinyl group.

The filler is one or a mixture with more of fumed silica, precipitated silica, silicone resin, silicon powders, calcium carbonate, aluminosilicate, diatomite, graphene, aluminum oxide, aluminum hydroxide, magnesium hydroxide and titanium dioxide.

The constitution controller is one or a mixture with more of micromolecule silicon oil end-capped with hydroxyl or alkoxyl groups, 1,1,1,3,3,3-hexamethyldisilazane, divinyl tetramethyl azane disilicide, diphenylsilanediol and alkyl alkoxy silane. A viscosity of the micromolecule silicon oil end-capped with hydroxyl or alkoxyl groups is 5-100 mm²/s at 25° C. The alkyl alkoxy silane is dimethyl dimethoxy silicane, diethyl dimethoxy silicane or dimethyldiethoxylsilane.

The plasticizing agent is one or a mixture with more of higher alcohols, higher fatty acid and metal salts thereof and higher aliphatic ester. The higher aliphatic ester is stearic acid, zinc stearate, lauryl alcohol, calcium stearate or glycerin monostearate.

The hydrogen-containing silicone oil is polysiloxane with at least three hydrogen atoms directly connected to Si. The at least three hydrogen atoms are located at an end of a main chain or a branched chain of the polysiloxane, or both ends of the main chain and the branched chain contain the at least three hydrogen atoms directly connected with Si. A content of the at least three hydrogen atoms is 0.1˜1.6%; the hydrogen-containing silicone oil is one or a mixture with more of linear chained polysiloxane, branched polysiloxane and annular polysiloxane.

The platinum catalyst is one or a mixture with more of chloroplatinic acid isopropanol solution, chloroplatinic acid tetrahydrofuran solution, chloroplatinic acid-divinyl tetramethyl disiloxane coordination complex, and chloroplatinic acid-1,3,5,7-tetravinyl-1,3,5,7-tetramethyl-octamethylcyclotetrasiloxane. A content of Pt atoms in the platinum catalyst is 100˜500000 ppm.

The retarding agent is one or a mixture with more of methylbutynol, 1-ethynyl-1-cyclohexanol, maleic acid with an alkynyl group or derivatives thereof, fumaric acid with an alkynyl group or derivatives thereof, polyvinyl polysiloxane, pyridine, unsaturated amides, organic phosphine and sub phosphate ester.

The dyeing slurry is a dyestuff with polysiloxane as a disperse medium, optimally is polysiloxane containing vinyl groups as the disperse medium.

The functional additive is one or a mixture with more of an antistatic agent, an antiseptic, an antimicrobial, a conductive filler, a flame retardant, and noctilucent powders.

Preferably, a molecular weight of the vinyl polysiloxane raw rubber is 550-800 thousands, and a content of the at least two vinyl groups is 0.01-2%.

A preparing method of the environmentally friendly wallpaper with weathering resistance and contaminating resistance is disposing the silicone rubber on the substrate layer to form the silicone rubber layer, pressing the silicone rubber layer for patterning to obtain a patterned silicone rubber layer, and vulcanizating the patterned silicone rubber layer to obtain the environmentally friendly wallpaper.

The preparing method specifically includes following steps: step 1: preparing the silicone rubber; step 2: calendering and attaching the silicone rubber and the substrate layer to obtain a calendered and attached material; step 3: incusing the calendered and attached material for patterning and to obtain a patterned wallpaper; step 4: vulcanizating the patterned wallpaper at 120-180° C. for 5-15 minutes to obtain the environmentally friendly wallpaper.

Compared with the prior art, the preparing method of the environmentally friendly wallpaper with weathering resistance and contaminating resistance of the disclosure has following beneficial effects.

1. The wallpaper of the disclosure consists of a substrate layer and a silicone rubber layer composite and connected together, and the wallpaper is environmentally friendly, harmless to human health, weathering resistant, waterproof, anti-contaminate, antiseptic, and flameproof.

2. The silicone rubber is disposed on the substrate layer to form the silicone rubber layer; the silicone rubber layer is pressed for patterning and vulcanizated to obtain the wallpaper. The preparing process is simple, environmentally friendly and high effective; the entire process is free from harmful substances released. Therefore, the preparing process is safe and environmentally friendly, and the prepared wallpaper is harmless to human health.

### BRIEF DESCRIPTION OF THE DRAWINGS

FIG. 1 is a schematic view of a preparing process of the disclosure.

1 is a substrate layer, 2 is a calender roller, 3 is a silicone rubber layer, 4 is an embossing roller, and 5 is a drying tunnel.

### DETAILED DESCRIPTION OF PREFERRED EMBODIMENTS

The accompanying drawing unrestrictedly discloses a structural schematic view of a preferred embodiment of the disclosure, and the technical solution of the disclosure will be illustrated in detail with reference to the accompanying drawing as follows.

### Embodiment 1

An environmentally friendly wallpaper with weathering resistance and contaminating resistance of the embodiment includes a substrate layer (may also be referred to as a base material layer) and a silicone rubber layer composite and connected together. A thickness of the silicone rubber layer is 0.1-1 mm.

The substrate layer is paper, textile cloth or other coiled materials.

The silicone rubber layer is formed by disposing silicone rubber on the substrate layer. The silicone rubber includes vinyl polysiloxane raw rubber, a filler, a constitution controller, a plasticizing agent, hydrogen-containing silicone oil, a platinum catalyst and a retarding agent.

The vinyl polysiloxane raw rubber is polysiloxane with at least two vinyl groups directly connected to Si, and an end or a branched chain of the polysiloxane contains vinyl groups, or the end and the branched chain both contain vinyl groups. A molecular weight of vinyl polysiloxane raw rubber is 550-800 thousands, and a content of vinyl groups is 0.01-2%.

The filler is one or more of fumed silica, precipitated silica, silicone resin, silicon powders, calcium carbonate, aluminosilicate, diatomite, graphene, aluminum oxide, aluminum hydroxide, magnesium hydroxide and titanium dioxide.

The constitution controller is one or more of micromolecule silicon oil end-capped with hydroxyl or alkoxyl groups, 1,1,1,3,3,3-hexamethyldisilazane, divinyl tetramethyl azane disilicide, diphenylsilanediol and alkyl alkoxy silane. The viscosity of micromolecule silicon oil end-capped with hydroxyl or alkoxyl groups is 5-100 mm²/s at 25° C. The alkyl alkoxy silane is dimethyl dimethoxy silicane, diethyl dimethoxy silicane or dimethyldiethoxylsilane.

The plasticizing agent is one or more of higher alcohols, higher fatty acid and metal salts thereof and higher aliphatic ester. The higher aliphatic ester is stearic acid, zinc stearate, lauryl alcohol, calcium stearate or glycerin monostearate.

The hydrogen-containing silicone oil such as polysiloxane containing hydrogen is polysiloxane with at least three hydrogen atoms directly connected to Si. The hydrogen atoms are located at an end of the main chain or a branched chain of polysiloxane, or both ends of the main chain contain hydrogen atoms directly connected with Si. A content of the hydrogen atoms is 0.1˜1.6%; the polysiloxane containing hydrogen is one or more of linear chained polysiloxane, branched polysiloxane and annular polysiloxane.

The platinum catalyst is one or more of chloroplatinic acid isopropanol solution, chloroplatinic acid tetrahydrofuran solution, chloroplatinic acid-divinyl tetramethyl disiloxane coordination complex, chloroplatinic acid-1,3,5,7-tetravinyl-1,3,5,7-tetramethyl-octamethylcyclotetrasiloxane. A content of Pt atoms in the platinum catalyst is 100˜500000 ppm.

The retarding agent is one or more of methylbutynol, 1-ethynyl-1-cyclohexanol, maleic acid with alkynyl groups or derivatives thereof, fumaric acid with alkynyl groups or derivatives thereof, polyvinyl polysiloxane, pyridine, unsaturated amides, organic phosphine and sub phosphate ester.

The dyeing slurry is a dyestuff with polysiloxane as a disperse medium. The dyeing slurry is an optional additive, which is benefit for preparing wallpapers with different colors, and optimally is polysiloxane containing vinyl groups as the disperse medium.

The functional additive is one or a mixture with more of an antistatic agent, an antiseptic, an antimicrobial, a conductive filler, a flame retardant, and noctilucent powders.

The silicone rubber of the embodiment is prepared by following ingredients with mass ratios.

The vinyl polysiloxane raw rubber, a molecular weight of which is 600 thousands, a content of vinyl groups in which is 0.05%, and the mass of which is 50 KG, and the vinyl polysiloxane raw rubber, a molecular weight of which is 600 thousands, a content of vinyl groups in which is 0.5%, and the mass of which is 50 KG.

The filler is 50 KG silica (A200).

The constitution controller is 4.5 KG hydroxy silicone oil with short chains.

The plasticizing agent is 0.25 KG glycerin monostearate.

After milling, 3.5 KG hydrogen-containing silicone oil (a hydrogen content is 1.6%, the viscosity is 50), the retarding agent, 0.035 KG (30000 ppm) platinum catalyst, 5 KG dyeing slurry, and the functional additive are added in.

The retarding agent is 0.007 KG 1-ethynyl-1-cyclohexanol.

The functional additive is 0.5 KG antiseptic.

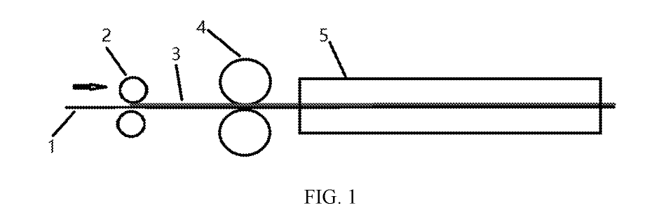

The preparing method of the environmentally friendly wallpaper with weathering resistance and contaminating resistance, as shown in FIG. 1, is disposing the silicone rubber on the substrate layer to form the silicone rubber layer, pressing the silicone rubber layer for patterning to obtain a patterned silicone rubber layer, and vulcanizating the patterned silicone rubber layer to obtain the environmentally friendly wallpaper.

Following steps are specifically included.

Step 1, the silicone rubber above is prepared.

Step 2, the silicone rubber is calendered and attached to the paper 1 by the calender roller; the calendering thickness is adjusted to be 0 5 mm, and the thickness of the obtained silicone rubber layer is 0.5 mm. The silicone rubber layers with various thicknesses can be obtained by adjusting the calendering thickness. In another embodiment of the disclosure, the calendering thickness is adjusted to be 0.15 mm, and the thickness of the obtained silicone rubber layer is 0.15 mm. In still another embodiment, the calendering thickness is adjusted to be 1 mm, and the thickness of the obtained silicone rubber layer is 1 mm.

Step 3, the material after calendering and attachment is pressed for patterning by the embossing roller 4 to obtain the patterned wallpaper.

Step 4, the pressed material is sent into the drying tunnel 5 whose temperature is 150° C. to be vulcanizated for 10 minutes to obtain the commercial wallpaper. In another embodiment, the pressed material is sent into the drying tunnel 5 whose temperature is 180° C. to be vulcanizated for 5 minutes to obtain the commercial wallpaper. In still another embodiment, the pressed material is sent into the drying tunnel 5 whose temperature is 120° C. to be vulcanizated for 15 minutes to obtain the commercial wallpaper.

### Embodiment 2

The differences between the embodiment and the embodiment 1 are ingredients and mass ratios of preparing the silicone rubber.

The vinyl polysiloxane raw rubber, a molecular weight of which is 800 thousands, a content of vinyl groups in which is 0.1%, and the mass of which is 50 KG, and the vinyl polysiloxane raw rubber, a molecular weight of which is 800 thousands, a content of vinyl groups in which is 1%, and the mass of which is 50 KG.

The filler is 40 KG silica (A200).

The constitution controller is 4.5 KG hydroxy silicone oil with short chains.

The plasticizing agent is 0.25 KG glycerin monostearate.

After milling, 5.5 KG hydrogen-containing silicone oil (a hydrogen content is 1.6%, the viscosity is 50), the retarding agent, 0.035 KG (30000 ppm) platinum catalyst, 5 KG dyeing slurry, and the functional additive are added in.

The retarding agent is 0.007 KG methylbutynol.

The functional additive is 0.5 KG antiseptic and 0.1 KG antimicrobial.

Another difference of the embodiment compared with the embodiment 1 is the calendering thickness is adjusted to be 0.15 mm.

### Embodiment 3

The differences of the embodiment compared with embodiment 1 and embodiment 2 are ingredients and mass ratios of preparing the silicone rubber.

The vinyl polysiloxane raw rubber, a molecular weight of which is 600 thousands, a content of vinyl groups in which is 0.05%, and the mass of which is 50 KG, and the vinyl polysiloxane raw rubber, a molecular weight of which is 600 thousands, a content of vinyl groups in which is 0.5%, and the mass of which is 50 KG.

The filler is 60 KG precipitated silica whose specific surface area is 200 m²/g.

The constitution controller is 4.5 KG hydroxy silicone oil with short chains.

The plasticizing agent is 0.25 KG glycerin monostearate.

After milling, 4 KG hydrogen-containing silicone oil (a hydrogen content is 1.6%, the viscosity is 50), the retarding agent, 0.035 KG (30000 ppm) platinum catalyst, 5 KG dyeing slurry, and the functional additive are added in.

The retarding agent is 0.007 KG 1-ethynyl-1-cyclohexanol.

The functional additive is 0.5 KG antiseptic.

Another difference of the embodiment compared with the embodiment 1 is the calendering thickness is adjusted to be 1 mm.

A comparative example is a randomly purchased conventional PVC wallpaper on the market.

The embodiment and the comparative example are underwent following tests.

### Environment Friendliness

### GB18585-2001 <<Indoor Decorating and Refurbishing Materials—Limit of Harmful Substances of Wallpapers>>.

| Harmful | Embodiment | Embodiment | Embodiment | Comparative |
|---|---|---|---|---|
| substance | 1 | 2 | 3 | example |
| Barium | 51 | 19 | 83 | 480 |
| Cadmium | None | None | None | 20 |
| Chromium | None | None | None | 54 |
| Lead | None | None | None | None |
| Arsenic | None | None | None | None |
| Mercury | None | None | None | None |
| Selenium | None | None | None | 112 |
| Antimony | None | None | None | None |
| Vinyl chloride | None | None | None | 3 |
| monomer | | | | |
| Formaldehyde | None | None | None | 58 |

### Weathering Resistance

### GB/T1865-1997 Paints and Varnishes—Artificial Weathering and Exposure to Artificial Radiation—Exposure to Filtered Xenon-Arc Radiation

| | Weathering resistance |
|---|---|
| Embodiment 1 | Unchanged for 600 h |
| Embodiment 2 | Unchanged for 600 h |
| Embodiment 3 | Unchanged for 600 h |
| Comparative example | Surface chalking, dehiscence, discoloration |

### Flame Resistance

### GB8624-2006 Classification for Burning Behavior of Building Materials and Products

| | Embodiment | Embodiment | Embodiment | Comparative |
|---|---|---|---|---|
| | 1 | 2 | 3 | example |
| Fire | B1 | B1 | B1 | B1 |
| performance | | | | |

### Mould Proof and Moisture Proof

### GB/T2423.16-1999 <<Test Methods—Mould Growth>>

The mould growth test with various moulds:

| | Anti-mould | |
|---|---|---|
| | level | State |
| Embodiment 1 | 0 | No visible mould under magnifier with |
| | | 50-fold amplification |
| Embodiment 2 | 0 | No visible mould under magnifier with |
| | | 50-fold amplification |
| Embodiment 3 | 0 | No visible mould under magnifier with |
| | | 50-fold amplification |
| Comparative | 1 | Visible with microscope, invisible with |
| example | | eyes |

### Contaminating Resistance

Comparison of cleansing the contamination with neutral cleaners and alcohol after 24 hours:

5: no stain

4: a little stain

3: some stain

2: considerable stain

1: contaminated

| | Embodiment | Embodiment | Embodiment | Comparative |
|---|---|---|---|---|
| | 1 | 2 | 3 | example |
| Anti- | 5 | 5 | 5 | 1 |
| contaminating | | | | |
| level | | | | |

It can be known that the environmentally friendly wallpaper with weathering resistance and contaminating resistance of the disclosure is prepared by a process of calendering and attaching-pressing for patterning-vulcanizating, the process thereof is simple and the production can be constant, resulting in high efficiencies; the entire process is free of harmful substances and polluters. The prepared wallpaper is environmentally friendly and wholesome, and the wallpaper has superior properties such as weathering resistance, contaminating resistance, flame resistance, moisture resistance and mould resistance.

The preferred embodiments illustrated with reference to the accompanying drawing above purely are for depicting the disclosure rather than limiting the objective of the disclosure or contents of the claims. Any simple modification and equivalents obtained according to the disclosure should be included in the protective scope of the disclosure.

What is claimed is:

1. An environmentally friendly wallpaper with weathering resistance and contaminating resistance comprising a substrate layer and a silicone rubber layer composite and connected together.

2. The environmentally friendly wallpaper with weathering resistance and contaminating resistance according to claim 1, wherein a thickness of the silicone rubber layer is 0.1-1 mm.

3. The environmentally friendly wallpaper with weathering resistance and contaminating resistance according to claim 1, wherein the substrate layer is paper or textile cloth.

4. The environmentally friendly wallpaper with weathering resistance and contaminating resistance according to claim 1, wherein the silicone rubber layer is formed by disposing a silicone rubber on the substrate layer, the silicone rubber comprises a vinyl polysiloxane raw rubber, a filler, a constitution controller, a plasticizing agent, a hydrogen-containing silicone oil, a platinum catalyst and a retarding agent.

5. The environmentally friendly wallpaper with weathering resistance and contaminating resistance according to claim 4, wherein ingredients and mass ratios of the silicone rubber are as follows:
the vinyl polysiloxane raw rubber: 90-110
the filler: 40-100
the constitution controller: 1-15
the plasticizing agent: 0.0001-2
the hydrogen-containing silicone oil: 0.001-10
the platinum catalyst: 0.0005-5
the retarding agent: 0.001-5
a dyeing slurry: 0-20
a functional additive: 0-30.

6. The environmentally friendly wallpaper with weathering resistance and contaminating resistance according to claim 5, wherein the vinyl polysiloxane raw rubber is a polysiloxane with at least two vinyl groups directly connected to silicon (Si), and an end of a main chain or a branched chain of the polysiloxane contains the at least two vinyl groups, or the end of the main chain and the branched chain both contain the at least two vinyl groups;
wherein the filler is one or a mixture with more of fumed silica, precipitated silica, silicone resin, silicon powders, calcium carbonate, aluminosilicate, diatomite, graphene, aluminum oxide, aluminum hydroxide, magnesium hydroxide and titanium dioxide;
wherein the constitution controller is one or a mixture with more of micromolecule silicon oil end-capped with hydroxyl or alkoxyl groups, 1,1,1,3,3,3-hexamethyldisilazane, divinyl tetramethyl azane disilicide, diphenylsilanediol and alkyl alkoxy silane, a viscosity of the micromolecule silicon oil end-capped with hydroxyl or alkoxyl groups is 5-100 mm²/s at 25° C., the alkyl alkoxy silane is dimethyl dimethoxy silicane, diethyl dimethoxy silicane or dimethyldiethoxylsilane;
wherein the plasticizing agent is one or a mixture with more of higher alcohols, higher fatty acid and metal salts thereof and higher aliphatic ester, the higher aliphatic ester is stearic acid, zinc stearate, lauryl alcohol, calcium stearate or glycerin monostearate;
wherein the hydrogen-containing silicone oil is polysiloxane with at least three hydrogen atoms directly connected to Si, the at least three hydrogen atoms are located at an end of a main chain or a branched chain of the polysiloxane, or both ends of the main chain and the branched chain contain the at least three hydrogen atoms directly connected with Si, a content of the at least three hydrogen atoms is 0.1˜1.6%; the hydrogen-containing silicone oil is one or a mixture with more of linear chained polysiloxane, branched polysiloxane and annular polysiloxane;
wherein the platinum catalyst is one or a mixture with more of chloroplatinic acid isopropanol solution, chloroplatinic acid tetrahydrofuran solution, chloroplatinic acid-divinyl tetramethyl disiloxane coordination complex, and chloroplatinic acid-1,3,5,7-tetravinyl-1,3,5,7-tetramethyl-octamethylcyclotetrasiloxane, a content of platinum (Pt) atoms in the platinum catalyst is 100˜500000 ppm;
wherein the retarding agent is one or a mixture with more of methylbutynol, 1-ethynyl-1-cyclohexanol, maleic acid with an alkynyl group or derivatives thereof, fumaric acid with an alkynyl group or derivatives thereof, polyvinyl polysiloxane, pyridine, unsaturated amides, organic phosphine and sub phosphate ester;
wherein the dyeing slurry is a dyestuff with polysiloxane as a disperse medium;
wherein the functional additive is one or a mixture with more of an antistatic agent, an antiseptic, an antimicrobial, a conductive filler, a flame retardant, and noctilucent powders.

7. The environmentally friendly wallpaper with weathering resistance and contaminating resistance according to claim 6, wherein a molecular weight of the vinyl polysiloxane raw rubber is 550-800 thousands, and a content of the at least two vinyl groups is 0.01-2%.

8. The environmentally friendly wallpaper with weathering resistance and contaminating resistance according to claim 6, wherein the dyeing slurry is a dyestuff with polysiloxane containing vinyl groups as the disperse medium.

9. A preparing method of an environmentally friendly wallpaper with weathering resistance and contaminating resistance, wherein the preparing method comprises:
disposing a silicone rubber on a substrate layer to form a silicone rubber layer;
pressing the silicone rubber layer for patterning to obtain a patterned silicone rubber layer; and
vulcanizating the patterned silicone rubber layer to obtain the environmentally friendly wallpaper;
wherein the environmentally friendly wallpaper with weathering resistance and contaminating resistance comprises a substrate layer and a silicone rubber layer composite and connected together.

10. The preparing method according to claim 9, wherein the steps of disposing the silicone rubber on the substrate layer to form the silicone rubber layer, pressing the silicone rubber layer for patterning to obtain the patterned silicone rubber layer, and vulcanizating the patterned silicone rubber layer to obtain the environmentally friendly wallpaper concretely comprise following steps of:
step 1: preparing the silicone rubber;
step 2: calendering and attaching the silicone rubber and the substrate layer to obtain a calendered and attached material;
step 3: incusing the calendered and attached material for patterning to obtain a patterned wallpaper;
step 4: vulcanizating the patterned wallpaper at 120-180 ° C. for 5-15 minutes to obtain the environmentally friendly wallpaper.

11. The preparing method according to claim 9, wherein a thickness of the silicone rubber layer is 0.1-1 mm.

12. The preparing method according to claim 9, wherein the substrate layer is paper or textile cloth.

13. The preparing method according to claim 9, wherein the silicone rubber layer is formed by disposing a silicone rubber on the substrate layer, the silicone rubber comprises a vinyl polysiloxane raw rubber, a filler, a constitution controller, a plasticizing agent, a hydrogen-containing silicone oil, a platinum catalyst and a retarding agent.

14. The preparing method according to claim 13, wherein ingredients and mass ratios of the silicone rubber are as follows:
the vinyl polysiloxane raw rubber: 90-110
the filler: 40-100
the constitution controller: 1-15
the plasticizing agent: 0.0001-2
the hydrogen-containing silicone oil: 0.001-10
the platinum catalyst: 0.0005-5
the retarding agent: 0.001-5
a dyeing slurry: 0-20
a functional additive: 0-30.

15. The preparing method according to claim 14, wherein the vinyl polysiloxane raw rubber is a polysiloxane with at least two vinyl groups directly connected to silicon (Si), and an end of a main chain or a branched chain of the polysiloxane contains the at least two vinyl groups, or the end of the main chain and the branched chain both contain the at least two vinyl groups;
wherein the filler is one or a mixture with more of fumed silica, precipitated silica, silicone resin, silicon powders, calcium carbonate, aluminosilicate, diatomite, graphene, aluminum oxide, aluminum hydroxide, magnesium hydroxide and titanium dioxide;
wherein the constitution controller is one or a mixture with more of micromolecule silicon oil end-capped with hydroxyl or alkoxyl groups, 1,1,1,3,3,3-hexamethyldisilazane, divinyl tetramethyl azane disilicide, diphenylsilanediol and alkyl alkoxy silane, a viscosity of the micromolecule silicon oil end-capped with hydroxyl or alkoxyl groups is 5-100 mm2/s at 25° C., the alkyl alkoxy silane is dimethyl dimethoxy silicane, diethyl dimethoxy silicane or dimethyldiethoxylsilane;
wherein the plasticizing agent is one or a mixture with more of higher alcohols, higher fatty acid and metal salts thereof and higher aliphatic ester, the higher aliphatic ester is stearic acid, zinc stearate, lauryl alcohol, calcium stearate or glycerin monostearate;
wherein the hydrogen-containing silicone oil is polysiloxane with at least three hydrogen atoms directly connected to Si, the at least three hydrogen atoms are located at an end of a main chain or a branched chain of the polysiloxane, or both ends of the main chain and the branched chain contain the at least three hydrogen atoms directly connected with Si, a content of the at least three hydrogen atoms is 0.1˜1.6%; the hydrogen-containing silicone oil is one or a mixture with more of linear chained polysiloxane, branched polysiloxane and annular polysiloxane;
wherein the platinum catalyst is one or a mixture with more of chloroplatinic acid isopropanol solution, chloroplatinic acid tetrahydrofuran solution, chloroplatinic acid-divinyl tetramethyl disiloxane coordination complex, and chloroplatinic acid-1,3,5,7-tetravinyl-1,3,5,7-tetramethyl-octamethylcyclotetrasiloxane, a content of platinum (Pt) atoms in the platinum catalyst is 100˜500000 ppm;
wherein the retarding agent is one or a mixture with more of methylbutynol, 1-ethynyl-1-cyclohexanol, maleic acid with an alkynyl group or derivatives thereof, fumaric acid with an alkynyl group or derivatives thereof, polyvinyl polysiloxane, pyridine, unsaturated amides, organic phosphine and sub phosphate ester;
wherein the dyeing slurry is a dyestuff with polysiloxane as a disperse medium;
wherein the functional additive is one or a mixture with more of an antistatic agent, an antiseptic, an antimicrobial, a conductive filler, a flame retardant, and noctilucent powders.

16. The preparing method according to claim 15, wherein a molecular weight of the vinyl polysiloxane raw rubber is 550-800 thousands, and a content of the at least two vinyl groups is 0.01-2%.

17. The preparing method according to claim 15, wherein the dyeing slurry is a dyestuff with polysiloxane containing vinyl groups as the disperse medium.
